(19) United States
(12) Patent Application Publication
(10) Pub. No.: US 2018/0320032 A1
(43) Pub. Date: Nov. 8, 2018

(54) WATER-DRAINABLE AIR-BARRIER TAPE FOR BUILDING TERMINATIONS

(71) Applicant: E I DU PONT DE NEMOURS AND COMPANY, Wilmington, DE (US)

(72) Inventors: CHRISTOPHER E. FETTERMAN, RICHMOND, VA (US); JAMES DEAN KATSAROS, MIDLOTHIAN, VA (US); BENJAMIN ALAN MEYER, MOSELEY, VA (US)

(21) Appl. No.: 15/954,990

(22) Filed: Apr. 17, 2018

Related U.S. Application Data
(60) Provisional application No. 62/501,248, filed on May 4, 2017.

(51) Int. Cl. C09J 7/38; C09J 109/00; C09J 7/24; C09J 7/28; E04B 1/66

(52) U.S. Cl. CPC C09J 7/383; C09J 109/00; C09J 7/243; C09J 2423/006; E04B 1/665; C09J 2409/00; C09J 7/28

(57) ABSTRACT

A multi-layered tape comprises in order (i) a substrate having first and second surfaces, (ii) a pressure-sensitive adhesive having first and second surfaces, the first surface of the adhesive being in contact with the first surface of the substrate, (iii) a plurality of continuous spaced apart elements attached to, or partially embedded into, the second surface of the adhesive that are positioned in an angular direction to the axis of the substrate length, and (iv) a release liner having a length and width so as to cover the second surface of the adhesive and the spaced apart elements.

### BACKGROUND

### 1. Field of the Invention

This invention pertains to a water-drainable air-barrier tape that is suitable for use in building terminations. It is particularly suited for buildings constructed with wooden sheathing.

### 2. Description of Related Art

It is essential for durable building structures to have paths for drainage of any moisture that may breach the building envelope, such that the moisture is not trapped in the wall cavity or on the sheathing. However, energy reduction goals and Code revisions mandate increasing requirements to construct building assemblies that are more resistant to air infiltration. The need to provide moisture drainage in the wall system while building an air tight assembly is problematic, given that openings in the assembly are considered necessary for drainage, but also result in air infiltration. A system that achieves an air seal under high pressures, while still allowing for water drainage without breach of the air seal, would resolve these requirements and be of high utility in any building envelope termination.

Sill pans and termination bars are used to terminate exterior drainage planes such as water-resistive barriers (WRB's) and/or flashing assemblies in order to allow moisture that either enters through a break in the building envelope from the exterior (such as a window leak, WRB penetration, seam failure, or incorrect installation) or from the interior wall cavity to escape to the exterior. However, these methods feature a physical opening (weep) in order to allow this drainage of moisture. These weep openings result in a source of air infiltration and will have detrimental impact on the performance of the assembly as an air barrier. Up to now, there is no termination system that can allow for moisture drainage from behind the termination while still maintaining the full air barrier performance of the building envelope.

United States Patent Application Publication No. 2014/0134408 to Milne and Vido describes a method and apparatus for making a water drainage-promoting wrap for applications such as housewrap and roofing underlayment. A substrate, which may be breathable or non-breathable, is conveyed through a nip between a rotating sleeve and a roll, the sleeve having a plurality of apertures therein. A fluid resin composition is fed into the sleeve and is fed out through the apertures in the sleeve as it rotates and as the substrate moves through the nip, forming spaced-apart spacer elements on a face of the substrate. The spacer elements are then dried or cured.

United States Patent Application Publication No. 2010/0139178 to Ehrman et al. discloses flashing material for a building structure. The flashing material includes a flexible water-resistive membrane having an upper textured surface with a series of separate, laterally paced-apart, elongate spacers bonded thereto. The elongate spacers can be polymeric filaments that define an air space and drainage paths across the upper surface of the membrane. Preferably, the filaments have a series of depressions formed therein that provide transverse drainage paths across the filaments. Sill, decking and other building structure assemblies and methods of making the flashing material are provided.

U.S. Pat. No. 8,074,409 to Goldberg et al pertains to a wall assembly includes a wall frame, a trough, a moisture transport spacer coupled to the wall frame and providing a substantial barrier to the passage of air and moisture vapor through the wall assembly, a moisture wicking sheet disposed at a bottom of the wall frame and extending from the moisture transport spacer to the trough, and an air seal disposed between the moisture wicking sheet and the bottom of the wall frame. The trough communicates with a dynamic ventilation system configured to remove moisture collected in the trough.

U.S. Pat. No. 8,001,736 to Goldberg et al teaches an exterior wall assembly includes a wall frame supporting an interior wall layer and an exterior wall layer opposite the interior wall layer, a flexible sheet disposed within the exterior wall assembly, and a seal attached to the flexible sheet and configured to prevent ingress of water toward the wall frame. The flexible sheet is configured to transport moisture from between the interior wall layer and the exterior wall layer to a location outside of the exterior wall assembly.

United States Patent Application Publication No. 2008/0307715 discloses a flashing material and method provides a moisture drainage passage to prevent water damage to buildings. The flashing material includes: (a) a planar portion for providing a drainage plane for the passage of moisture along a plane defined by said planar portion, wherein said planar portion includes a porous sheet capable of permitting the passage of water therethrough along the drain plain, and/or a water impervious sheet having a surface defining said drainage plane; (b) a water-impervious layer which is bonded on a first side to the planar portion; and, preferably (c) a layer of adhesive applied to a second side of the water-impervious layer. The flashing material is particularly useful for installing a portal such as a window or door in an opening in a wall, or for sealing joints in roofs, for installing skylights and similar such uses.

The disclosure of U.S. Pat. No. 8,490,338 to Longo provides a self-adhesive, flexible tape for flashing exterior wall openings. The tape is a composite comprising a barrier layer having an exterior surface and an interior surface and an adhesive layer overlying the interior surface. The barrier layer exterior surface is patterned to provide a gravity drainage path in both the tape machine direction (MD) and tape cross machine direction (CD).

U.S. Pat. No. 6,901,712 to Borenstein discloses a self-adhering air and moisture barrier sheet membrane for structural surfaces of buildings, which is permeable to the passage of water vapor, is comprised of a water vapor permeable sheet onto one surface of which is applied an adhesive in a non-continuous film.

### SUMMARY OF THE INVENTION

This invention pertains to a multi-layered tape having a length, width and thickness wherein the tape comprises in order:

(i) a substrate having first and second surfaces,

(ii) a pressure-sensitive adhesive having first and second surfaces, the first surface of the adhesive being in contact with the first surface of the substrate,

(iii) a plurality of continuous spaced apart elements attached to, or partially embedded into, the second surface of the adhesive that are positioned in an angular direction to the axis of the substrate length, and

(iv) a release liner having a length and width so as to cover the second surface of the adhesive and the spaced apart elements, wherein the thickness and width of the spaced apart elements, the texture of the outer surface of the elements and the spacing between the elements are such that a building termination comprising the tape minus the release liner passes the air barrier requirement of ASTM E2178-13 of not exceeding 0.004 cfm/sf air infiltration at 1.57 psf pressure and the drainage test of ASTM E2273-03(2011) with at least 98 percent efficiency.

The invention further pertains to a joint between two water-resistant barriers in a building comprising lower and upper water-resistive barriers both having inner and outer surfaces wherein the lower edge of the upper water-resistive barrier overlaps the upper edge of the lower water-resistive barrier and wherein a multilayer tape covers the lap joint between the outer surfaces of the lower and upper water-resistive barriers, the multilayer tape comprising in order

(i) a substrate having first and second surfaces,

(ii) a pressure-sensitive adhesive having first and second surfaces, the first surface of the adhesive being in contact with the first surface of the substrate,

(iii) a plurality of continuous spaced apart elements attached to, or partially embedded into, the second surface of the adhesive that are positioned in an angular direction to the axis of the substrate length, and wherein the pressure-sensitive adhesive and the plurality of spaced apart elements contact the outer surfaces of the upper and lower water-resistive barriers at the lap joint and wherein the joint between the two water-resistive barriers passes the air barrier requirement of ASTM E2178-13 of not exceeding 0.004 cfm/sf air infiltration at 1.57 psf pressure and the drainage test of ASTM E2273-03(2011) with at least 98 percent efficiency.

### BRIEF DESCRIPTION OF THE DRAWINGS

FIG. 1 is a sectional view of one embodiment of a multi-layered tape.

FIG. 2 is a plan view of one side of one embodiment of a multi-layered tape.

FIG. 3A is a front view of a joint between two weather-resistant barriers in a building.

FIG. 3B is a sectional side view of FIG. 3A.

FIGS. 4A, 4B, 4C, 4D, 4E and 4F are plan or end views of variants of spaced apart drainage elements.

### DETAILED DESCRIPTION

### Multi-Layered Tape

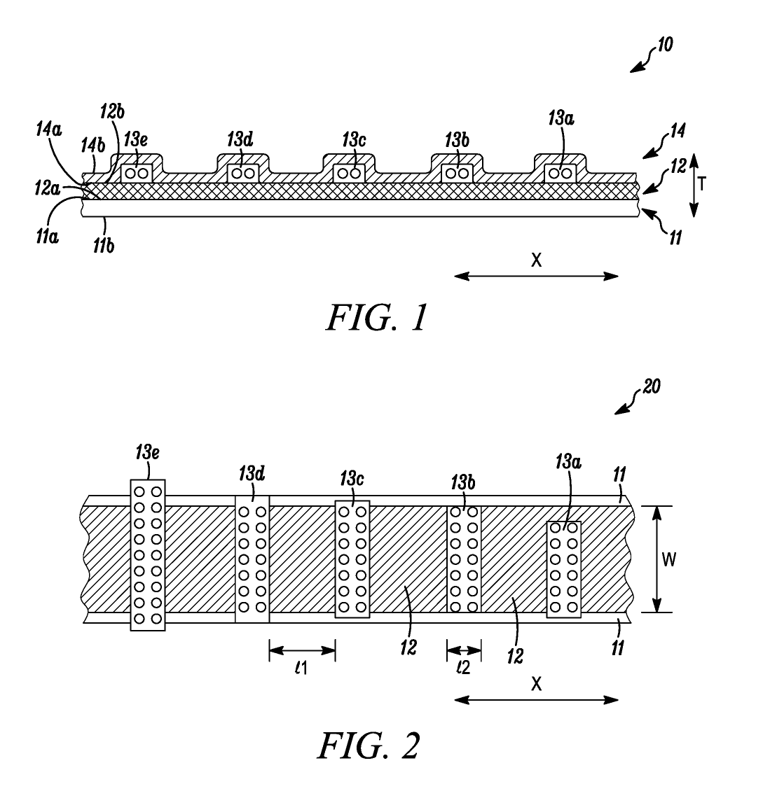

FIG. 1 is a sectional view of one embodiment of a multi-layered tape having a length, width and thickness. The length is shown by direction “X” which is also referred to herein as “the axis of the substrate length” The thickness direction is shown as “T”. The tape comprises in order:

(i) a substrate 11 having first and second surfaces, 11a and 11b respectively,

(ii) a pressure-sensitive adhesive 12 having first and second surfaces, 12a and 12b respectively, the first surface 12a of the adhesive being in contact with the first surface 11a of the substrate,

(iii) a plurality of continuous spaced apart elements (strips), for example 13a to 13e on the surface of, or partially embedded into, the second surface 12b of the adhesive, the elements being positioned in an angular direction to the axis of the substrate length, and

(iv) a release liner 14 having a length and width so as to cover the second surface 12b. of the adhesive. The liner has a first surface 14a that contacts the adhesive and covers the spaced apart elements.

### Substrate

In some embodiments, the substrate is a polymeric or metallic sheet. A preferred metallic substrate is aluminum. Preferred polymeric substrates are polyethylene (PE) or polypropylene (PP). A suitable polyethylene substrate is a nonwoven web of flash-spun plexifilamentary high-density PE (HDPE) available from E.I. DuPont de Nemours and Company, Wilmington, Del. under the tradename TYVEK. A suitable polypropylene substrate is a laminated sheet of fibers and film available from FiberWeb Inc., Old Hickory, Tenn. under the tradename TYPAR.

### Pressure-Sensitive Adhesive (PSA)

Any suitable PSA can be used provided it has sufficient bond strength to bond to the substrate and the spaced apart elements. In one embodiment, the PSA is a butyl rubber. The width of the PSA is shown as W in FIG. 2.

### Spaced Apart Elements

A plurality of continuous spaced apart elements, for example 13a to 13e as in FIGS. 1 and 2 are on the surface of, or partially embedded into, the second surface 12b of the PSA, the elements being positioned in an angular direction to the axis of the substrate length. In one embodiment, the elements are positioned perpendicular to the axis of the substrate length as shown in FIG. 2. The elements have a width 12 as shown in FIG. 2.

The element may partially cover the top portion, fully cover or extend beyond the full width of the PSA 12, as for example in 13a (partially cover), 13b (fully cover) or 13c, 13d or 13e (extend beyond). In some embodiments, the element may partially cover, fully cover or extend beyond the full width of the substrate 11 as shown respectively at 13a, 13c, 13d or 13e.

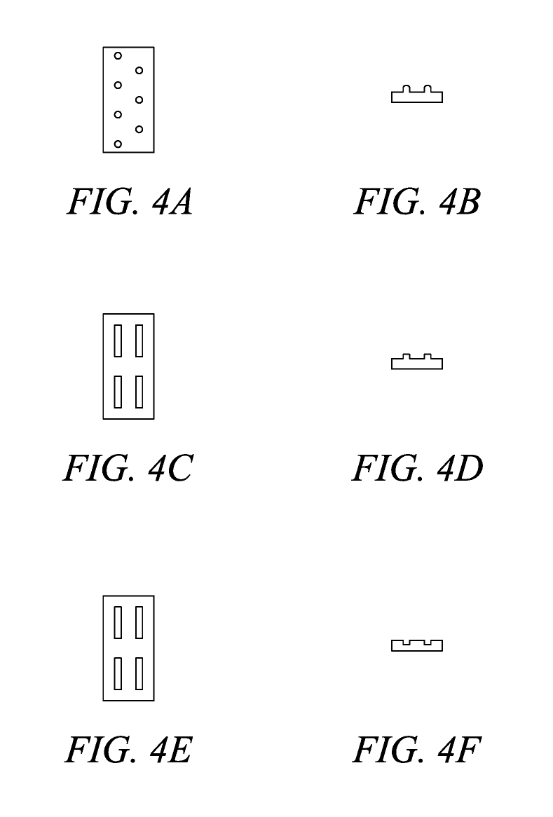

In some embodiments, the element may be a polycarbonate or hot melt adhesive. In some embodiments, the element is embossed, grooved (channels) or ridged on one side with the other side being flat and smooth. Any suitable embossing pattern may be utilized such a squares, circles, rectangles, diamonds or chevrons. FIGS. 4A and 4B show plan and end views respectively of a ridged element comprising two rows of ridges where the ridges in the rows are circular and offset with respect to each other. FIG. 2 shows a plan view of a ridged elements 13a to 13e with each element comprising two rows of ridges where the ridges in the rows are circular and not offset with respect to each other. FIGS. 4C and 4D show plan and end views respectively of a ridged element comprising two rows of ridges where the ridges in the rows are extended and not offset with respect to each other. Other ridge shapes and positioning of adjacent ridges may also be employed. FIGS. 4E and 4F show plan and end views respectively of a grooved (channeled) element comprising two rows of grooves where the grooves in the rows are not offset with respect to each other. In some embodiments, the thickness of the element is greater than 0.25 mm. In other embodiments, the thickness of the element is at least 0.5 mm. In some embodiments, the width of the element is at least 6.35 mm. In other embodiments, the width of the element is at least 12.7 mm. In some embodiments, the ridge height may be up to 0.6 mm thick although other heights may also be suitable. In other embodiments, the element has no ridges and is flat (smooth). In the context of this application, the element thickness is the distance from the non-ridged lower surface of the element to the top of the ridge and the ridge height is the distance from the upper ridged surface of the element to the top of the ridge. The elements are located on the PSA such that the non-ridged side of the element is in contact with the adhesive.

When grooved or channeled elements are employed. It is preferable that the channel depth is at least 0.3 mm.

The thickness and width of the spaced apart elements, the texture of the outer surface of the elements and the spacing between the elements are such that a building termination comprising the tape minus the release liner passes the air barrier requirement of ASTM E2178-13 of not exceeding 0.004 cfm/sf air infiltration at 1.57 psf pressure and the drainage test of ASTM E2273-03(2011) with at least 98 percent efficiency.

### Release Liner

The release liner 14 has a length and width so as to cover the second surface of the adhesive 12. The liner may be of any suitable material such as a polymeric film, a paper or a foil provided it can peel free (release) easily from the adhesive. Preferably the liner is scored, perforated or slit in the direction of the axis of the substrate length. This facilitates removal of the liner during use of the tape.

### Use of the Tape as a Joint Sealant

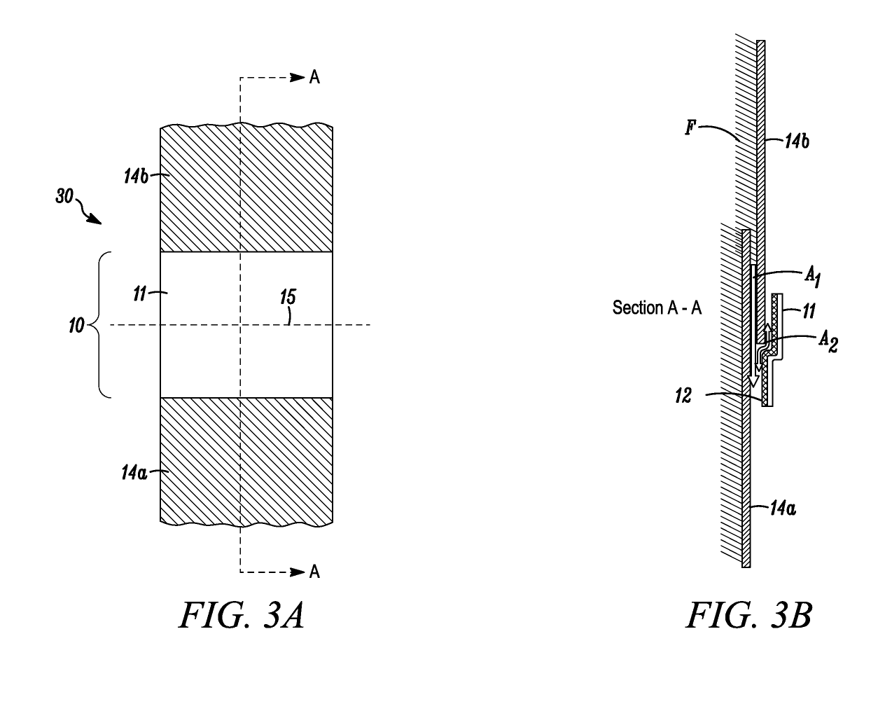

The tape may be used to provide a water drainable joint between two water-resistive barriers in a building. FIG. 3B shows a wooden panel, board or facade F of a building. Lower and upper water-resistive barriers, 14a and 14b respectively, both have inner and outer surfaces with the inner surface contacting the wooden board F. The lower edge of the upper water-resistive barrier 14b overlaps the upper edge of the lower water-resistive barrier 14a in water shedding, shingled fashion. A multilayer tape 10 covers the lap joint between the outer surfaces of the lower and upper water-resistive barriers, the multilayer tape comprising in order

(i) a substrate 11 having first and second surfaces 11a and 11b,

(ii) an adhesive 12 being in contact with the second surface 11a of the substrate and

(iii) a plurality of continuous spaced apart elements, for example 13a to 13e, attached to the second surface 12a of the adhesive that are positioned in an angular direction to the axis of the substrate length, and wherein the pressure-sensitive adhesive and the plurality of spaced apart elements contact the outer surfaces of the upper and lower water-resistive barriers 14a and 14b at the lap joint and wherein the joint between the two water-resistive barriers passes the air barrier requirement of ASTM E2178-13 of not exceeding 0.004 cfm/sf air infiltration at 1.57 psf pressure and the drainage test of ASTM E2273-03(2011) with at least 98 percent efficiency. The release liner 14 is removed from the adhesive 12 of the tape as part of the process of positioning the tape over the lap joint. Downward arrow A1 of FIG. 3B shows the drainage path for fluid draining from behind the upper water-resistive barrier 14b. Bi-directional arrow A2 shows an air path through the joint. The tape therefore provides a drainage path and an air flow path at the joint.

Any building termination comprising the tape minus the liner passes air barrier requirement of ASTM E2178-13 of not exceeding 0.004 cfm/sf air infiltration at 1.57 psf pressure and the drainage test of ASTM E2273-03(2011) with at least 98 percent efficiency. A building termination is sometimes known as a building transition or building edge.

### Test Methods

Air barrier performance was determined as specified in ASTM E2178-13.

The drainage test was carried out in accordance with ASTM E2273-03(2011).

### EXAMPLES

Examples prepared according to the process or processes of the current invention are indicated by numerical values. Control or Comparative Examples are indicated by letters.

In all examples, the substrate was a commercially available flash-spun polyethylene sheet of continuous filament fibers having a nominal areal weight of 83 gsm. The sheet is available from E.I. DuPont de Nemours and Company, Wilmington, Del. under the tradename Tyvek, grade 1083X and was creped. The nominal width was 101 mm (4 inches).

In all examples, the pressure-sensitive adhesive was a butyl based rubber. The adhesive was provided at a nominal width of 101 mm and at a nominal thickness of 0.5 mm.

In all examples, the spacer elements were made of polycarbonate and were provided in thicknesses ranging from 0.25 mm (10 mil) to 0.76 mm (30 mil). The strips were used in widths (I2) of 6.35 mm (0.25 inch), 12.7 mm (0.5 inch) or 19.05 mm (0.75 inch), the latter two being made by side by side assembly of 6.35 mm strips. The side of the strip in contact with the adhesive was smooth while the other side was either smooth (S), had raised dots or ridges (D) on the surface or grooves (channels) (C) in the surface.

Except for Example 2, in all the examples and comparative examples, the spacer elements covered the full width of the adhesive as shown for example at 13b in FIG. 2. In Example 2, the spacer element covered 67% of the width of the adhesive.

The release liner was a silicone coated paper.

The various configuration tested are shown in Table 1. The spacing, (I1) between all strips was 305 mm (12 inches).

### Air Barrier Test

This was carried out with two 1 m×1m sheets of Tyvek® CommercialWrap® from DuPont and the multilayered tape described above assembled as in FIG. 3B. One sheet is an upper wrap 14b and the other a lower wrap 14a. The two sheets were overlapped such that the lower sheet overlapped the upper sheet by 152 mm (6 inches) with the overlap being on the inside of the two sheets. The tape was positioned to fully cover the overlap join with 51 mm (2 inches) of tape overlapping each sheet. This assembly was then tested according to the ASTM standard.

### Drainage Test

This was carried out with two sheets of Tyvek® CommercialWrap® from DuPont and the multilayered tape described above overlapped and joined as per the air barrier test. The joined sheet was 244 cm mm (8 feet) long by 122 cm (4 feet) wide. A water supply hole was cut into the top of the sheet. This assembly was then tested according to the ASTM standard with water being poured into the back of the sheet through the hole a then collected at the bottom of the sheet.

The results from both these tests are shown in Table 1.

TABLE 1

| | | | | ASTME2178 |
|---|---|---|---|---|
| | | | ASTM E2273 | (Air Barrier Test) |
| | Element | Element | (Drain Test) | Air Infiltration |
| | Thickness | Width | % Water | cfm/ft² @ |
| Example | (mm) | (mm) | Collected | 1.57 lbs./ft² |
| 1 | 0.76C | 0.25 | >98% | 0.002 |
| 2 | 0.76C | 0.25 | >98% | 0.001 |
| 3 | 0.41S | 0.25 | >98% | 0.0003 |
| Comp A | 0.25S | 0.25 | <90% | 0.0004 |
| Comp B | 0.76C | 0.5 | >98% | 0.005 |
| 6 | 0.5D | 0.25 | >98% | 0.001 |
| Comp C | 0.76C | 0.75 | >98% | 0.010 |
| 8 | 0.5D | 0.5 | >98% | 0.001 |

“C” denotes a spacer element having channels (grooves).
“S” denotes a smooth spacer element
“D” denotes raised dots (ridges) on the spacer element.

For the drainage test, the passing value is a water collection of greater than 98% of the input water volume. For the air barrier test the passing value is an air infiltration not exceeding 0.004 cfm/sf at 1.57 psf pressure.

The only difference between Example 3 and Comparative Example A was that the element thickness of Comparative Example A was thinner. It is believed that the combination of a thinner element and a smooth element outer surface was the cause of the failed drainage test result. In a similar manner, the only difference between Example 2 and Comparative Examples B and C was that the comparative examples had wider spacer elements. It is believed that the combination of a wider elements and channeled element outer surfaces was the cause of the failed air infiltration test result. Although Example 8 and Comparative Example B had elements of the same width, the element thickness of Example 8 was thinner and the element had raised dots on the outer element surface whereas Comprarative Example B had channels on the outer surface of the element. These findings show that only specfic combinations of thickness and width of the spaced apart elements, the texture of the outer surface of the elements and the spacing between the elements will satisfy both ASTM reqiurements and therefore appropriate selection of these features is required.

What is claimed is:

1. A multi-layered tape having a length, width and thickness wherein the tape comprises in order:
(i) a substrate having first and second surfaces,
(ii) a pressure-sensitive adhesive having first and second surfaces, the first surface of the adhesive being in contact with the first surface of the substrate,
(iii) a plurality of continuous spaced apart elements attached to, or partially embedded into, the second surface of the adhesive that are positioned in an angular direction to the axis of the substrate length, and
(iv) a release liner having a length and width so as to cover the second surface of the adhesive and the spaced apart elements,
wherein the thickness and width of the spaced apart elements, the texture of the outer surface of the elements and the spacing between the elements are such that a building termination comprising the tape minus the release liner passes the air barrier requirement of ASTM E2178-13 of not exceeding 0.004 cfm/sf air infiltration at 1.57 psf pressure and the drainage test of ASTM E2273-03(2011) with at least 98 percent efficiency.

2. The tape of claim 1 wherein the substrate is a polymeric or metallic sheet.

3. The tape of claim 1 wherein the pressure-sensitive adhesive is a butyl rubber adhesive.

4. The tape of claim 1 wherein the element partially covers the top portion, fully covers or extends beyond the full width of the pressure-sensitive adhesive.

5. The tape of claim 1 wherein the element partially covers the top portion, fully covers or extends beyond the full width of the substrate.

6. The tape of claim 1 wherein the element is positioned perpendicular to the axis of the substrate length.

7. The tape of claim 1 wherein the element is a polycarbonate or hot melt adhesive.

8. The tape of claim 1 wherein the element is embossed, grooved or ridged.

9. The tape of claim 1 wherein the liner is scored, perforated or slit in the direction of the axis of the substrate length.

10. The tape of claim 2 wherein the polymer of the sheet is polyethylene or polypropylene.

11. A joint between two water-resistant barriers in a building comprising lower and upper water-resistive barriers both having inner and outer surfaces wherein the lower edge of the upper water-resistive barrier overlaps the upper edge of the lower water-resistive barrier and wherein a multilayer tape covers the lap joint between the outer surfaces of the lower and upper water-resistive barriers, the multilayer tape comprising in order
(i) a substrate having first and second surfaces,
(ii) a pressure-sensitive adhesive having first and second surfaces, the first surface of the adhesive being in contact with the first surface of the substrate,
(iii) a plurality of continuous spaced apart elements attached to, or partially embedded into, the second surface of the adhesive that are positioned in an angular direction to the axis of the substrate length, and wherein the pressure-sensitive adhesive and the plurality of spaced apart elements contact the outer surfaces of the upper and lower water-resistive barriers at the lap joint and wherein the joint between the two water-resistive barriers passes the air barrier requirement of ASTM E2178-13 of not exceeding 0.004 cfm/sf air infiltration at 1.57 psf pressure and the drainage test of ASTM E2273-03(2011) with at least 98 percent efficiency.
